(19) United States
(12) Patent Application Publication
(10) Pub. No.: US 2004/0236599 A1
(43) Pub. Date: Nov. 25, 2004

(54) Method and apparatus for receiving a product notice for a subordinate component

(76) Inventor: Jack Ivan J'maev, Chino, CA (US)

Correspondence Address: Jack J'maev, SUITE 110, 11800 CENTRAL AVE., CHINO, CA, 91710, US

(21) Appl. No.: 10/848,996

(22) Filed: May 18, 2004

Related U.S. Application Data
(63) Continuation-in-part of application No. 10/615,412, filed on Jul. 7, 2003.
(60) Provisional application No. 60/471,927, filed on May 19, 2003.

(51) Int. Cl. G06F 17/60

(52) U.S. Cl. 705/1

(57) ABSTRACT

A method and apparatus for receiving a product notice wherein a subordinate component provides a product identifier. The product identifier is received. A product notice message is also received. A target product identifier is included in the received product notice message. An indication is generated by comparing the product identifier received from the subordinate component and the target product identifier included in the received product notice message.

### RELATED APPLICATIONS

This present application is a continuation-in-part of application Ser. No. 10/615,412 filed on Jul. 7, 2003, entitled “Method and Apparatus for Receiving Product Notices”, by J'maev, currently pending, for which the priority date for this application is hereby claimed and which is hereby incorporated by reference herein in its entirety and further claims priority to provisional application serial No. 60/471,927 filed on May 19, 2003 also by J'maev entitled “Method and Apparatus for Recall of Products Having Subordinate Components Subject to Recall”.

### BACKGROUND

The complicated array of products that are subject to recall in today's technologically-advanced society points to a need for a recall management system that can deal effectively with the complexity of the product recall problem. More specifically, today's products typically comprise several subordinate components that, individually, are subject to recall. Modern automobiles provide a good example that illustrates the problem. Today's automobiles are manufactured by assembling components that may be provided by, literally, dozens of vendors. An automobile may comprise, in part, an engine, a transmission, a drive train, wheels, tires, a body, seats, seat belts, air bags, and windows. The same automobile might comprise an entertainment system, a cruise control system, lights, displays of various kinds, wiring, carpeting, and various electric motors. This list includes just some of the obvious components that are clearly in evidence to the casual observer.

An automobile itself, of course, is subject to recall. However, various components of the automobile may be subject to recall apart from the recall of the automobile itself. Tires constitute an excellent example of components that are subject to recall. If safety issues with a particular make and model of tires are identified, then any automobile on which the tires are installed becomes subject to “induced recall.” The electronic components that control air bags likewise are subject to recall as are the electronic components that make up the electronic ignition and emission control systems in a typical automobile of today. The prior art provides little assistance in the management of the recall of such complicated assemblies of “recallable components”.

Generally, the prior art requires that the manufacturer of products maintain a database of components that were used to manufacture a given product (such as an automobile). Then when a particular component becomes subject to recall, the manufacturer must search that database to determine which product incorporated that component, to determine the identity of the purchasers of the product, and to provide each of the purchasers with a product recall notice. As has been described in the co-pending applications, the prior art—being a user-centric method—cannot support the recall of products where a given component has already been replaced. Neither can the prior art support the recall of products that have been resold by the original purchaser except in the case where the seller or the new owner take care to notify the manufacturer of the change of ownership.

While the automobile has been used as an example of a product that comprises several recallable components, many, many products share this characteristic with automobiles. Computers, for example, comprise processor chips made by various manufacturers, motherboards (themselves comprising a plethora of chips that come from several vendors), keyboards, displays of various kinds, network components, power supplies, and so on, any one of which may be subject to recall. Household appliances such as refrigerators comprise an electric motor, a compressor, plumbing, insulation, and so on that may come from separate vendors. The co-pending applications outline several classes of products for which the prior art fails to support a product recall protocol that can protect public safety while protecting manufacturers from product liability. The existence of subordinate products within primary products subject to recall further complicates the product recall problem and illustrates the need for improvement in the art of product recall management.

### SUMMARY

A method and apparatus for receiving a product notice wherein a subordinate component provides a product identifier. The product identifier is received. A product notice message is also received. A target product identifier is included in the received product notice message. An indication is generated by comparing the product identifier received from the subordinate component and the target product identifier included in the received product notice message.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that describes one example of a method for managing the recall of a product that comprises subordinate components that are, themselves, subject to recall;

FIG. 2 is a flow diagram depicting one illustrative method of receiving a PID of a component of a product subject to recall;

FIG. 3 is a flow diagram that depicts one alternative illustrative method of receiving the PID of a component of a product subject to recall;

FIG. 4 is a flow diagram that describes one exemplary method by which to determine whether a PID associated with a recall notice matches the PID of any subordinate component of a product subject to recall;

FIG. 5 is a block diagram of one embodiment of an apparatus that is capable of managing a recall notice for a product when the product comprises subordinate components that are, themselves, subject to recall;

FIG. 6 is a block diagram of one illustrative embodiment of a notice receiver 250 capable of managing a recall notice according to the present invention;

FIG. 7 is a block diagram of an alternative embodiment of an apparatus that is capable of managing a recall notice for a product when the product comprises subordinate components that are, themselves, subject to recall;

FIG. 8 is a block diagram of an alternative embodiment of a notice receiver 251 capable of managing a recall notice according to the present invention;

FIG. 9 is a flow diagram that describes another variation of the method of the present invention that employs the use of short-range wireless identification device for receipt of a subordinate PID; and

FIG. 10 is a block diagram of one exemplary embodiment of a notice receiver 252 capable of managing a recall notice when smart chips are used to identify subcomponents subject to recall.

### DETAILED DESCRIPTION

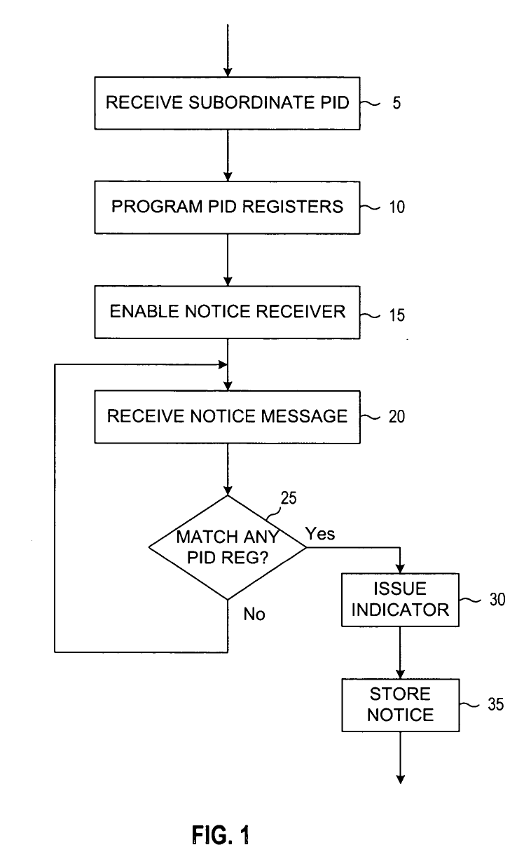

FIG. 1 is a flow diagram that describes one example of a method for managing the recall of a product that comprises subordinate components that are, themselves, subject to recall. One illustrative variation of the method, according to the present invention, is applied by a device installed in a product subject to recall wherein said product comprises one or more subordinate components that, themselves, are subject to recall. According to this illustrative variation of the method, each subordinate component is assigned a product identifier (PID). The term “Product Identifier” is defined in the first introduced incorporated reference. This variation of the method, accordingly, provides that the PID of a subordinate component is received (step 5). According to another variation of the method, the received PID is stored in a register (step 10) and a notice receiver is enabled (step 15) in a manner described more fully in a copending application.

In one use case of particular interest, a message is received comprising a recall notice (step 20). The recall notice may comprise one or more PIDs corresponding to products or components being recalled. Of course, during any given time interval, a large number of such messages may be received, and it is unlikely that any given message pertains to the particular product under consideration. According to one variation of the method of the present invention, the received message is analyzed to determine whether a PID associated with the message matches the PID stored in any register (step 25). If a match does occur, then an indication of product recall is issued (step 30), and a record of the received notice is stored (step 35). In a like manner, other types of user notifications are delivered by one other variation of this method. Again, other types of notifications include, but are not limited to product upgrade notices and advertising notices.

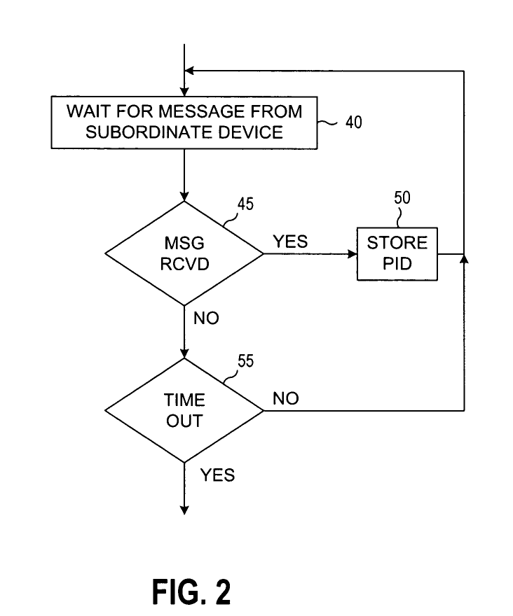

FIG. 2 is a flow diagram depicting one illustrative method of receiving a PID of a component of a product subject to recall. According to one variation of the method, the present illustrative method is performed soon after manufacture of the product is completed. In another variation on the method, the present illustrative method applies whenever the product is activated for normal use. One example of such activation occurs when the ignition switch of an automobile is turned on. These examples that illustrate the circumstances under which the method may be performed are not in any way intended to limit the scope of the present invention. One variation of this illustrative method, which may be called the “interrupt” mode of operation, calls for waiting for an identification message from a subordinate device (step 40). When an identification message is received (step 45), one variation of the method calls for extracting a PID from the message and storing the PID (step 50). According to another variation of the method, the PID is stored in a register. According to yet another variation of the method that applies when the product comprises more than one component subject to recall, additional messages are received and stored. One particular variation of the method teaches that the procedure is repeated until a time out occurs (step 55). The meaning of the time out implies, according to one variation of the method, that an interval of time has elapsed that is sufficient to assure reception of the PIDs for all possible subordinate devices in the product.

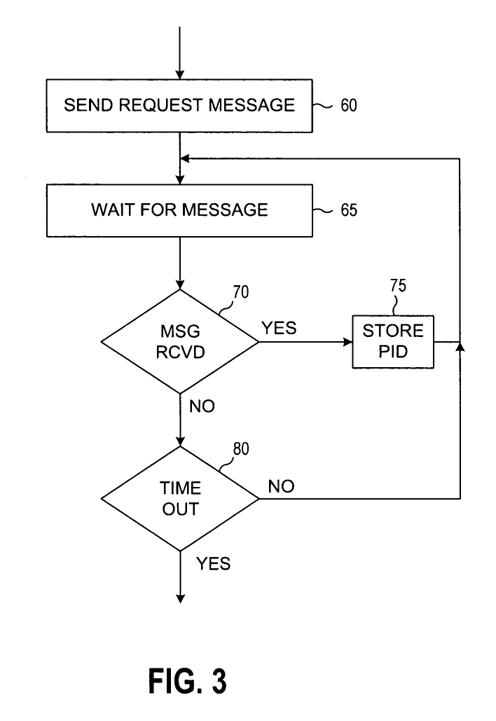

FIG. 3 is a flow diagram that depicts one alternative illustrative method of receiving the PID of a component of a product subject to recall. One variation of this alternative illustrative method, which may be called the “polling” mode of operation, calls for sending an identification request message (step 60). In one variation of the method, a master process intercommunicates with subordinate devices by means of a local area network (LAN) and is able to transmit a polling message that is received by a subordinate device. In yet another variation of the present method, an identification request message is conveyed to the network in a broadcast manner such that a plurality of subordinate devices receive the polling message and wherein each of said device then responds by conveying an identification message to the master process. After transmitting a polling message, one variation of the method provides for waiting for a response message (step 65) from the subordinate device. When a response message is received (step 70), another variation of the method provides that a PID is extracted from the message, and the PID is stored (step 75). According to another variation of the method, more than one such message is received, so the procedure is repeated until a time out occurs (step 80), said time out operating to assure that PIDs for all possible subordinate devices have been received.

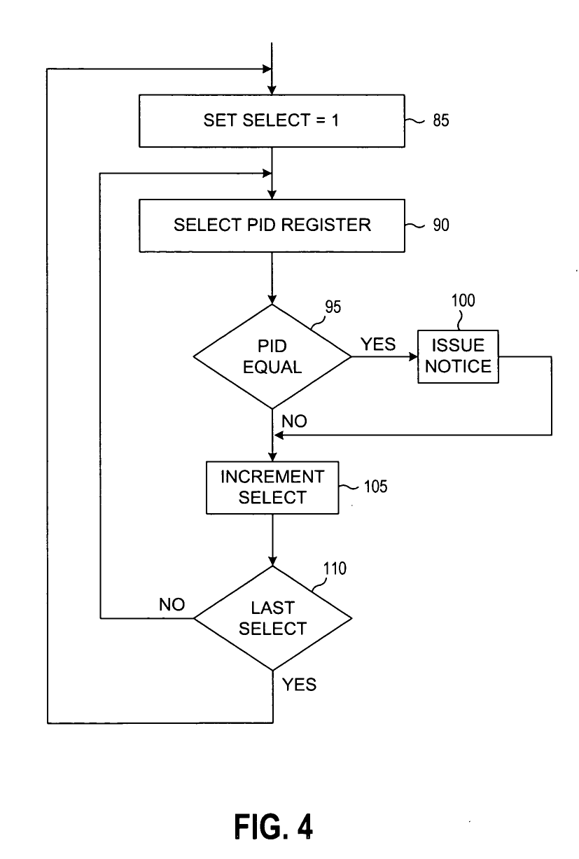

FIG. 4 is a flow diagram that describes one exemplary method by which to determine whether a PID associated with a recall notice matches the PID of any subordinate component of a product subject to recall. According to one illustrative variation of the method, an arbitrary variable called SELECT is defined and set to 1 (step 85). The name of the SELECT variable is introduced only for purposes of illustration and in no way is intended to limit the scope of the invention. In fact, the variable may take any name whatsoever. A PID register is selected according to the value of SELECT (step 90). For example, according to one variation of the method, PID register #1 is selected when SELECT=1, PID register #2 is selected when SELECT=2,and so on. Again, the particular mapping of values of SELECT into the set of PID registers is arbitrary, and this illustrative example does not limit the intended scope of the present invention. The PID associated with the received recall notice then is compared with the PID stored in the selected PID register (step 95). If the PID in the received recall notice does not match the PID stored in the selected PID register, then the value of SELECT is incremented (step 105). If the last SELECT value has not been considered (step 110), then the procedure is repeated by selecting another PID register (step 90). If no PID register is found that matches the PID associated with the received recall notice, and if the last value of SELECT has been considered (step 110), then SELECT is reset to 1 (step 85). In one variation of the method, the procedure begins again when a new recall, or other user notice is received. If the PID in the received recall notice does match the PID stored in a particular PID register (step 95), then an indication of product recall is issued (step 100), and the process continues by incrementing the value of SELECT (step 105). In one particular variation of the method, a received recall notice comprises more than one PID. When this is true, the method of FIG. 4 is repeated for each of the PIDs contained in the received recall notice.

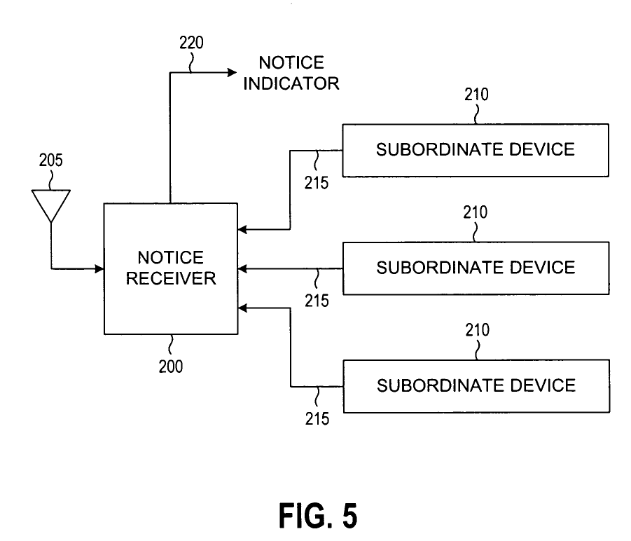

FIG. 5 is a block diagram of one embodiment of an apparatus that is capable of managing a recall notice for a product when the product comprises subordinate components that are, themselves, subject to recall. One embodiment of this apparatus comprises a notice receiver 200 capable of receiving a recall notice comprising one or more PIDs associated with components subject to recall. In one particular embodiment, the recall notice is received in the form of a wireless signal sensed on an antenna 205, although the notice may be received in other forms in other embodiments. According to one embodiment, the receiver is commensurate with the receiver described in the first incorporated reference and is augmented with the capabilities described herein. The apparatus, according to one alternative embodiment, further comprises at least one subordinate device 210 that is communicatively coupled to the notice receiver 200. In one illustrative mode of operation, the subordinate devices 210 pass their respective PID values 215 to the notice receiver 200. The notice receiver 200 compares each of the subordinate PIDs with the PID or PIDs associated with the received recall notice. The notice receiver 200 asserts the notice indicator 220 when the PID of one or more of the subordinate devices matches any PID associated with the received recall notice.

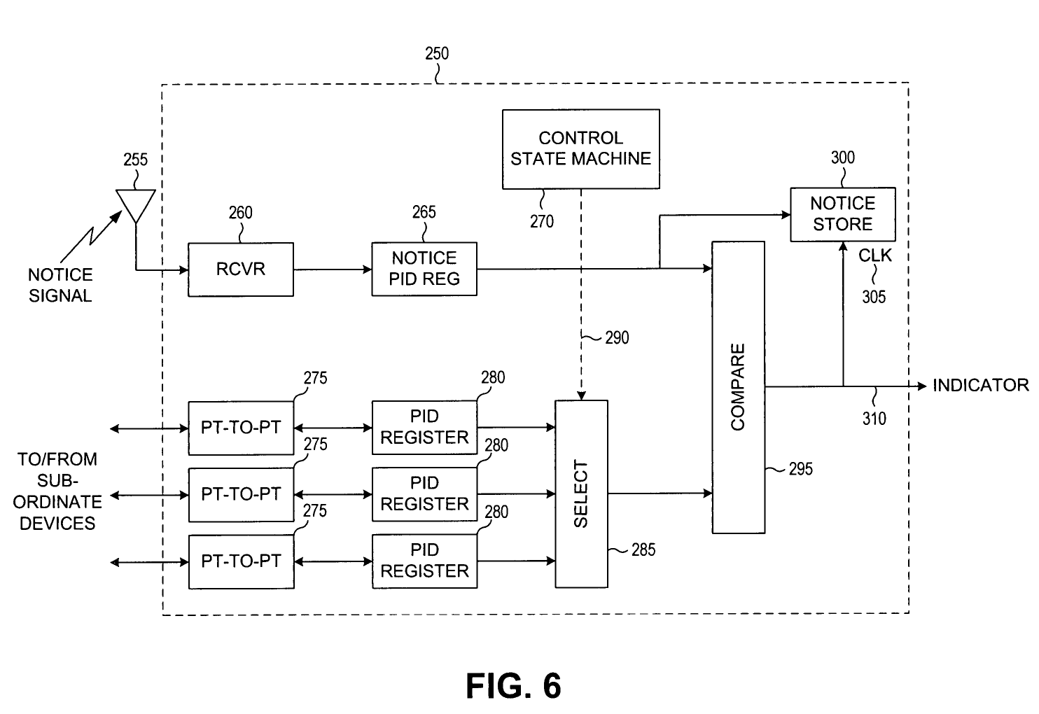

FIG. 6 is a block diagram of one illustrative embodiment of a notice receiver 250 capable of managing a recall notice according to the present invention. This embodiment of the notice receiver 250 comprises an antenna 255 by means of which a wireless message comprising a recall or other product notice can be received. In other embodiments of the notice receiver 250, the recall or other product notice may be received by other means. For example, the signal in one embodiment is transmitted over a power line. In another embodiment, the signal is transmitted over a telephone line. Other embodiments may employ other media. None of these examples of means by which a recall notice can be received is intended to limit the scope of the present invention. The reader is asked to refer to the first incorporated reference to fully understand other alternative embodiments of the receiver. One embodiment of the notice receiver 250 further comprises a receiver 260 and a notice PID register 265 capable of storing a PID associated with a recall or other product user notice. The receiver 260 is capable of converting the received signal into a form that can be stored in the notice PID register 265. One embodiment of the notice receiver 250 further comprises one or more point-to-point communication units 275, each such unit being capable of intercommunicating with one subordinate device subject to recall. Another embodiment of the notice receiver 250 still further comprises one or more PID registers 280 that are associated in one to one correspondence with the point-to-point communication units 275. Each such PID register 280, therefore, is associated with one subordinate component subject to recall. Each PID register is capable of storing a PID associated with the corresponding subordinate device.

The notice receiver 250, according to one illustrative embodiment, further comprises a control state machine 270, a selection unit 285, a comparison unit 295, and a notice storage unit 300. In one illustrative mode of operation a recall notice comprising the PID is received, and the notice PID is stored in the notice PID register 265. The contents of the notice PID register 265 also are presented to one input of the comparison unit 295 and to the input of the notice storage unit 300. The point-to-point communication units 275 communicate with their respective subordinate devices, and each communication unit 275 receives a PID that is stored in a PID register 280. The control state machine 270, by means of control signal 290, causes the selection unit 285 to present the contents of each PID register 280 to one input of the comparison unit 295. When the PID associated with one of the subordinate devices matches the notice PID, then the output of the comparison unit 295 is asserted, thus asserting a recall indicator 310. The recall indicator 310 also functions as a clock signal 305 that acts to cause the notice storage unit 300 to store the contents of the notice PID register 265 as discussed more fully in a co-pending application.

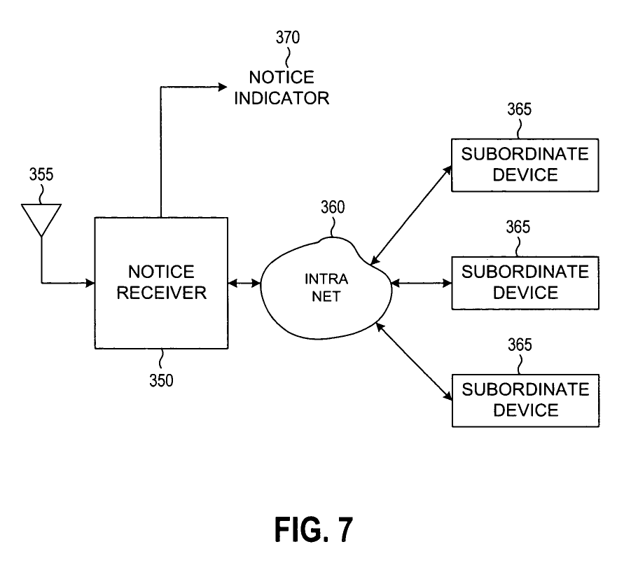

FIG. 7 is a block diagram of an alternative embodiment of an apparatus that is capable of managing a recall notice for a product when the product comprises subordinate components that are, themselves, subject to recall. This alternative embodiment comprises a notice receiver 350 capable of receiving a recall notice comprising one or more PIDs associated with components subject to recall. One embodiment of the apparatus further comprises a wired or wireless local area network or “intra net” 360 and one or more subordinate devices 365. The notice receiver 350 in one embodiment is capable of intercommunicating with each of the subordinate devices 365 by means of the intra net 360. In one illustrative mode of operation of one embodiment of this apparatus, the notice receiver 350 receives, by means of an antenna 355, a recall notice comprising a notice PID. Again, various alternative means of receiving a notice, as described in the first copending reference, are intended to be within the scope of the present invention. The notice receiver 350 then intercommunicates with the subordinate devices 365 through the medium of the intra net 360. If the notice receiver 350 determines that one of the subordinate devices needs to be recalled, then the notice receiver 350 asserts the notice indicator 370.

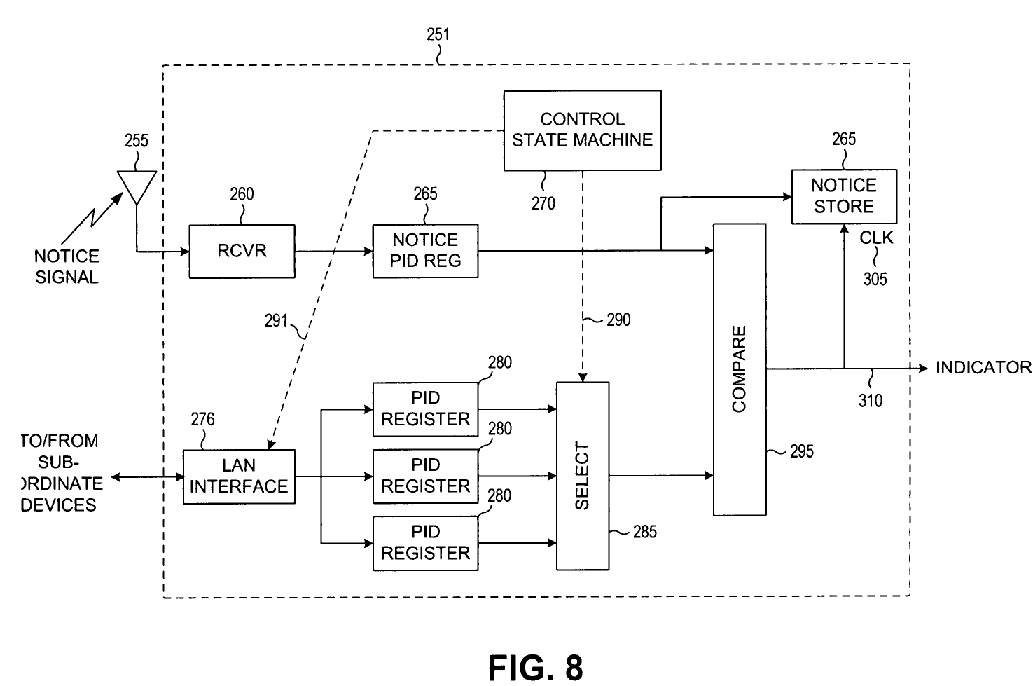

FIG. 8 is a block diagram of an alternative embodiment of a notice receiver 251 capable of managing a recall notice according to the present invention. This alternative embodiment is similar to the embodiment of a notice receiver 250 disclosed in the discussion of FIG. 6. Like numerals in FIG. 6 and FIG. 8 denote like elements. The notice receiver 251 differs from the notice receiver 250 in that the point-to-point receivers 275 are replaced with a local area network (LAN) interface 276 capable of intercommunicating with subordinate devices that form part of the product subject to recall. The control state machine, by means of control signal 291, communicates with the LAN interface 276 to cause the LAN interface to acquire PID values from subordinate components, said PID values then being stored in PID registers 280. Other aspects of the notice receiver 251 as diagramed in FIG. 8 are identical to corresponding aspects of the notice receiver 250 as disclosed in the discussion of FIG. 6.

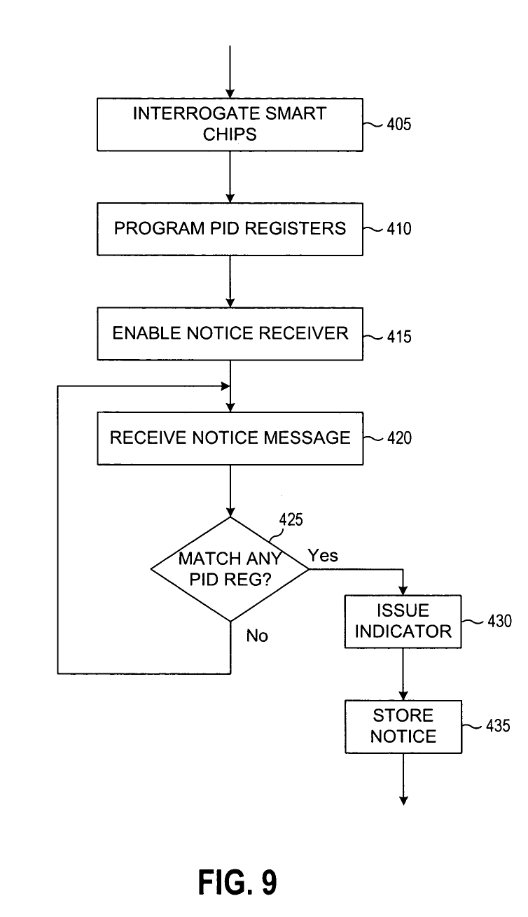

FIG. 9 is a flow diagram that describes another variation of the method of the present invention that employs the use of short-range wireless identification device for receipt of a subordinate PID. According to this variation of the method, embedded short-range wireless devices are used to identify components of the product subject to recall. According to one particular variation of the method, the tires on an automobile have embedded therein short-range wireless identification devices or “smart chips” that are installed during the process of manufacture. When smart chips are used, one variation of the method teaches that the smart chips are electromagnetically interrogated (step 405) to determine their respective PIDs. According to another variation of the method, the received PID is stored in a register (step 410) and a notice receiver is enabled (step 415) in a manner described more fully in a copending application. In one use case of particular interest, a message is received comprising a recall notice (step 420). The recall notice may comprise one or more PIDs corresponding to products or components being recalled. During any given time interval, a large number of such messages may be received, and it is unlikely that any given message pertains to the particular product under consideration. According to one variation of the method of the present invention, the received message is analyzed to determine whether a PID associated with the message matches the PID stored in any register (step 425). If a match does occur, then an indication of product recall is issued (step 430), and a record of the received notice is stored (step 435).

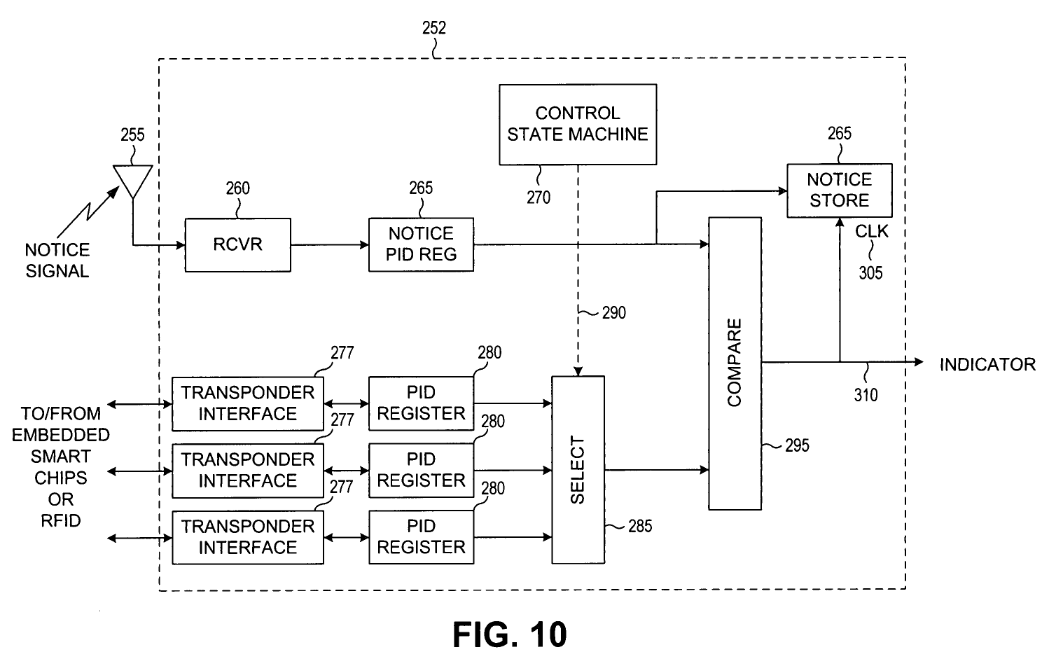

FIG. 10 is a block diagram of one exemplary embodiment of a notice receiver 252 capable of managing a recall notice when smart chips are used to identify subcomponents subject to recall. This alternative embodiment is similar to the embodiment of a notice receiver 250 disclosed in the discussion of FIG. 6. Like numerals in FIG. 6 and FIG. 10 denote like elements. The notice receiver 252 differs from the notice receiver 250 in that the point-to-point receivers are replaced with transceivers 277 capable of intercommunicating with smart chips that are embedded in the product. The smart chip transceivers 277 acquire PIDs from the smart chips; the PIDs are then stored in PID registers 280. Other aspects of the notice receiver 252 as diagramed in FIG. 8 are identical to corresponding aspects of the notice receiver 250 as disclosed in the discussion of FIG. 6. According to one alternative embodiment, the smart-chip transceivers are housed proximate to the wheel wells of an automobile allowing interrogation of the smart-chips embedded in each tire resulting in the retrieval of PIDs for each tire and storage of those PIDs in the notice receiver 252. It should be noted that the present invention is not intended to be limited in scope to “smart-chips” which is an industry standard radio-frequency identification tagging mechanism. Any wireless means for retrieval of a PID from subordinate component that are electronically tagged with an identifier constitutes a proper embodiment of the present invention.

Alternative Embodiments

While this invention has been described in terms of several alternative methods and exemplary embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

What is claimed is:

1. A method for receiving a product notice for a subordinate component:
receiving a product identifier from a subordinate component;
receiving a product notice message;
issuing an indication when the product identifier included in the product notice message is substantially equivalent to the product identifier received from the subordinate component.

2. The method of claim 1 wherein receiving a product identifier from a subordinate component comprises:
receiving an identification message from a subordinate component;
extracting a product identifier from the identification message; and
storing the product identifier.

3. The method of claim 1 wherein receiving a product identifier from a subordinate component comprises:
dispatching a identification request message;
receiving in response to the identification request message an identification message from a subordinate component;
extracting a product identifier from the identification message; and
storing the product identifier.

4. The method of claim 1 wherein receiving a product identifier from a subordinate component comprises interrogating a wireless product identification transponder so as to determine a product identifier.

5. The method of claim 1 wherein issuing an indication comprises:
selecting a first product identification register;
comparing a product identifier included in a product notice message to the contents of the selected product identification register;
issuing a notification based on the comparison; and
selecting a subsequent product identification register.

6. A subordinate aware product notice receiver comprising:
subordinate product identifier receiver capable of receiving a product identifier from a subordinate component;
product notice receiver capable of receiving a product notice message that includes a target product identifier; and
comparator capable of generating an indication according to the product identifier received from the subordinate component and the target product identifier included in a received product notice message.

7. The product notice receiver of claim 6 wherein the subordinate product identifier receiver comprises a point-to-point interface capable of interfacing with a subordinate component.

8. The product notice receiver of claim 6 wherein the subordinate product identifier receiver comprises at least of a local area network interface, a wired local area network interface and a wireless local area network interface.

9. The product notice receiver of claim 6 wherein the product notice receiver comprises a wireless product notice receiver.

10. The product notice receiver of claim 6 further comprising:
one or more product identification registers each capable of storing a product identifier received by the subordinate product identifier receiver;
control state machine that generates selection signal; and
selection unit capable of propagating the contents of a product identification register selected according to the selection signal and wherein the comparator receives the output of the selection unit.

11. The product notice receiver of claim 6 further comprising a notice storage unit capable of storing a product notice message received by the product notice receiver according to the indication generated by the comparator.

12. The product notice receiver of claim 6 further comprising an interrogation unit capable of retrieving a product identifier from a subordinate component.

13. The product notice receiver of claim 12 wherein the interrogation unit comprises at least one of a smartchip reader and a radio frequency identification reader.
